(19) United States
(12) Patent Application Publication
(10) Pub. No.: US 2018/0364865 A1
(43) Pub. Date: Dec. 20, 2018

(54) TOUCH CONTROL METHOD, USER EQUIPMENT, INPUT PROCESSING METHOD, MOBILE TERMINAL AND INTELLIGENT TERMINAL

(71) Applicant: NUBIA TECHNOLOGY CO., LTD., Shenzhen (CN)

(72) Inventors: Xin LI, Shenzhen (CN); Jianhua CHI, Shenzhen (CN)

(21) Appl. No.: 15/781,955

(22) PCT Filed: Nov. 16, 2016
(86) PCT No.: PCT/CN2016/106171

§ 371 Date: Jun. 6, 2018

(30) Foreign Application Priority Data
Dec. 7, 2015 (CN) 201510896531.8

(51) Int. Cl. G06F 3/041; G06F 3/0488; G06F 3/0346

(52) U.S. Cl. CPC G06F 3/0418; G06F 3/04886; G06F 3/0346; G06F 3/044; G06F 2203/04808; G06F 2203/04104; G06F 2203/04803

(57) ABSTRACT

The present disclosure provides a touch control method, user equipment, input processing method, mobile terminal, intelligent terminal and storage medium of computer. The touch control method includes: detecting a touch signal generated on a touch panel; identifying a touch point according to the touch signal; detecting a split screen state and a rotation angle of the mobile terminal; determining whether the touch point is located in an edge touch area or a normal touch area of the first display area, or located in an edge touch area or a normal touch area of the second display area according to the identified touch point, the rotation angle and the split screen state; and performing a corresponding instruction based on the determination result.

### FIELD OF TECHNOLOGY

The present disclosure generally relates to the field of communication and, more particularly, relates to a touch control method, user equipment, input processing method, mobile terminal, intelligent terminal, and computer storage medium.

### BACKGROUND

With the development of technology of the mobile terminal, the frames of the mobile terminal become narrower and narrower. In order to improve the user's input experience, edge input technology (for example, edge touch) has been developed.

In existing edge input technology, after detection of touch point information, the driver layer determines whether the touch occurs in the edge input area according to the touch point information.

However, in practice, due to the diversity of the input chips, the method of obtaining the touch point information in the driver layer is also highly targeted, which leads to the need to determine the type of event (whether it is an edge input event or not), and the input chip needs to be modified and transplanted differently, which is large workload and error-prone.

On the other hand, when the driver layer reports an event, it can choose either protocol A or protocol B. The protocol B distinguishes finger IDs. And the implementation of the edge input needs to rely on the finger ID, which is used to compare the data that is clicked twice by the same finger when inputting at multiple points. Therefore, the existing input scheme can only support the protocol B, while the driver using the protocol A cannot be supported.

Moreover, in the existing technology, the edge touch area is fixed. When the display screen of the mobile terminal is split, the edge touch area cannot be adaptively changed to control different display areas respectively.

Therefore, the existing technology has certain problems and needs to be improved.

### BRIEF SUMMARY OF THE DISCLOSURE

The technical problem to be solved in the embodiment of the present invention lies in that, the edge touch method of the above-mentioned mobile terminal cannot adapt to the defects of the screen-split, and a touch control method, a user equipment, an input processing method, a mobile terminal, and a smart terminal are provided.

The technical solution adopted by the present disclosure to solve its technical problems is:

In a first aspect, a touch control method is provided, applied in a mobile terminal, the mobile terminal comprises a first display area and a second display area, the method comprising:
detecting a touch signal generated on a touch panel;
dentifying a touch point according to the touch signal;
detecting a split screen state and a rotation angle of the mobile terminal;
determining whether the touch point locates in an edge touch area or a normal touch area of the first display area, or locates in an edge touch area or a normal touch area of the second display area according to the identified touch point, the rotation angle and the split screen state; and
performing a corresponding instruction based on a determination result.

In one embodiment, the rotation angle comprising: rotate 0 degrees, rotate 90 degrees clockwise, rotate 180 degrees clockwise, rotate 270 degrees clockwise, rotate 90 degrees counterclockwise, rotate 180 degrees counterclockwise and rotate 270 degrees counterclockwise.

In one embodiment, the split screen state comprising: up-and-down split screen and left-and-right split screen.

In a second aspect, a user device is provided, comprising a first display area and a second display area, and further comprising: a touch screen, a motion sensor and a processor;
the touch screen comprises a touch panel and a touch controller;
the touch panel is configured to detect a touch signal generated on the touch panel;
the touch controller is configured to identify a touch point according to the touch signal;
the motion sensor is configured to detect a rotation angle of the user device;
the processor comprises a driver module, an application framework module, and an application module;
the driver module is configured to obtain an input event based on the touch signal and report to the application framework module;
the application framework module is configured to determine whether the touch point is located in an edge touch area or a normal touch area of the first display area, or located in an edge touch area or a normal touch area of the second display area according to the location of the touch point of the reported input event, a rotation angle and a split screen state of the user device, and identify according to a determination result and report an identified result to the application module;
the application module is configured to performing a corresponding instruction based on the determination result.

The driver module, the application framework module, and the application module can use a central processing unit (CPU), a digital signal processor (DSP), or a programmable logic array (FPGA, Field-Programmable Gate Array) to execute the processing.

In a third aspect, an input processing method is provided, applied in a mobile terminal, the mobile terminal comprises a first display area and a second display area, the method comprising:
obtaining, by a driver layer, an input event based on a touch signal generated by a user through an input device, and reporting to an application framework layer;
according to a rotation angle, a split screen state of the mobile terminal, and the reported input event, determining, by the application framework layer, whether the input event is an edge input event or a normal input event located in the first display area, or is an edge input event or a normal input event located in the second display area; identifying according to a determination result, and reporting an identified result to an application layer;
performing, by the application layer, a corresponding instruction based on the reported identified result.

In one embodiment, the method further comprising: creating an input device object with a device ID for each input event.

In one embodiment, wherein creating an input device object with a device ID for each input event comprising: making the normal input event corresponds to a touch screen with a first device ID; setting, by the application framework layer, a second input device object with a second device ID corresponding to the edge input event.

In one embodiment, wherein obtaining, by a driver layer, an input event based on a touch signal generated by a user through an input device, and reporting to an application framework layer comprising: assigning, by the driver layer, a number to distinguish fingers for each touch point, and reporting the input event using protocol A.

In one embodiment, wherein obtaining, by a driver layer, an input event based on a touch signal generated by a user through an input device, and reporting to an application framework layer comprising: reporting, by the driver layer, the input event using protocol B; the method further comprising: assigning, by the application framework layer, a number to distinguish fingers for each touch point in the input event.

In one embodiment, wherein, the rotation angle of the mobile terminal comprising: rotate 0 degrees, rotate 90 degrees clockwise, rotate 180 degrees clockwise, rotate 270 degrees clockwise, rotate 90 degrees counterclockwise, rotate 180 degrees counterclockwise and rotate 270 degrees counterclockwise.

In one embodiment, wherein, the split screen state comprising: up-and-down split screen and left-and-right split screen.

In a forth aspect, a mobile terminal is provided, the mobile terminal comprises a first display area and a second display area, further comprising:
an input device;
a motion sensor, configured to detect a current state of the mobile terminal;
a driver layer, configured to obtain an input event generated by a user through the input device and report to an application framework layer;
the application framework layer, configured to determine whether the input event is an edge input event or a normal input event located in the first display area, or is an edge input event or a normal input event located in the second display area according to a rotation angle, a split screen state of the mobile terminal and the reported input event, identify according to a determination result and report an identified result to an application layer;
the application layer, configured to perform a corresponding instruction based on the reported identified result.

In one embodiment, wherein the normal input event corresponds to a first input device object with the first device ID; the application framework layer further configured to set a second input device object with a second device ID corresponding to the edge input event.

In one embodiment, wherein, the driver layer reports the input event by using protocol A or protocol B, when protocol A is used to report the input events, an event obtain module is configured to assign a number to distinguish fingers for each touch point; when protocol B is used to report the input event, the application framework layer is configured to assign a number to distinguish fingers for each touch point.

In one embodiment, wherein, the driver layer comprises an event obtain module configured to obtain the input event generated by a user through an input device.

In one embodiment, wherein the application framework layer comprises an input reader; the mobile terminal further comprises a device node set between the driver layer and the input reader, configured to notify the input reader to obtain the input event; the input reader is configured to traverse the device node to obtain and report the input event.

In one embodiment, the rotation angle of the mobile terminal comprises: rotate 0 degrees, rotate 90 degrees clockwise, rotate 180 degrees clockwise, rotate 270 degrees clockwise, rotate 90 degrees counterclockwise, rotate 180 degrees counterclockwise and rotate 270 degrees counterclockwise.

In one embodiment, wherein, the application framework layer further comprising: a first event processing module, configured to calculate and report a coordinate of the input event reported by an input reader; a first determination module, configured to determine whether the input event is an edge input event according to the current state of the mobile terminal and the coordinate reported by the first event processing module, and report the input event when the input event is not an edge input event.

In one embodiment, wherein, the application framework layer further comprising: a second event processing module, configured to calculate and report a coordinate of the input event reported by an input reader; a second determination module, configured to determine whether the input event is an edge input event according to the current state of the mobile terminal and the coordinate reported by the second event processing module, and report the input event when the input event is an edge input event.

In one embodiment, wherein the split screen state comprising: up-and-down split screen and left-and-right split screen.

In one embodiment, wherein the application framework layer further comprising: an event dispatch module, configured to report the event reported by the second determination module and the first determination module.

In one embodiment, wherein the application framework layer further comprising:
a first application module;
a second application module;
a third determination module, configured to determine whether the input event is an edge input event according to a device ID of the input event reported by the event dispatch module, report the input event to the first application module when the input event is an edge input event and report the input event to the second application module when the input event is not an edge input event, wherein:
the first application module is configured to identify the normal input event according to relevant parameters of normal input event and report identify result to the application layer;
the second application module is configured to identify the edge input events according to relevant parameters of edge input event and report identify result to the application layer.

In one embodiment, wherein the input device is the touch screen of the mobile terminal; the touch screen comprises at least one edge input area and at least one normal input area.

In one embodiment, wherein the input device is the touch screen of the mobile terminal; the touch screen comprises at least one edge input area, at least one normal input area and at least one transition area.

The event obtain module, the first event processing module, the first determination module, the second event processing module, the second determination module, the event dispatch module, the first application module, the second application module, and the third determination module can use a central processing unit (CPU), a digital signal processor (DSP), or a programmable logic array (FPGA, Field-Programmable Gate Array) to execute the processing.

In a fifth aspect, an intelligent terminal with a communication function is provided, the intelligent terminal comprises a first display area and a second display area, and further comprising: a touch screen, a motion sensor and a processor;
the touch screen comprises a touch panel and a touch controller;
the touch panel is configured to detect a touch signal generated on the touch panel;
the touch controller is configured to identify a touch point according to the touch signal;
the motion sensor is configured to detect a rotation angle of the user device;
the processor comprises a driver module, an application framework module, and an application module;
the driver module is configured to obtain an input event based on the touch signal and report to the application framework module;
the application framework module is configured to determine whether the touch point is located in an edge touch area or a normal touch area of the first display area, or located in an edge touch area or a normal touch area of the second display area according to the location of the touch point in the reported input event, a rotation angle and a split screen state of the user device, and identify according to the determination result and report the identified result to the application module;
the application module is configured to performing a corresponding instruction based on the determination result.

The driver module, the application framework module and the application module can use a central processing unit (CPU), a digital signal processor (DSP), or a programmable logic array (FPGA, Field-Programmable Gate Array) to execute the processing.

In a sixth aspect, a computer storage medium is provided, the computer storage medium stores computer executable instructions, wherein the computer executable instructions configured to perform the touch control method and the input processing method described above.

The touch control method, user equipment, input processing method, mobile terminal, and smart terminal of the present invention, can realize the conversion edge touch area according to the rotation and split screen state of the touch screen, so as to better adapt to the user's operation and improve the user experience. On the other hand, because the operation of area A and the operation of area C can only be distinguished at the application framework layer, and the virtual devices are also established at the application framework layer, it can avoid the reliance on hardware when distinguishing between area A and area C in the driver layer. By setting the touch point number, the fingers can be distinguished, which is compatible with A protocol and B protocol. Further, because functions can be integrated into the operating system of the mobile terminal, applicable to different hardware, different kinds of mobile terminals, and having good portability. The input reader automatically saves all parameters of a touch point (coordinates, numbers, etc., of the touch point) to facilitate the subsequent judgment of edge input (for example, FIT).

### BRIEF DESCRIPTION OF THE DRAWINGS

FIG. 1 is a schematic diagram of the hardware structure of the mobile terminal according to an embodiment of the present disclosure;

FIG. 2 is a schematic diagram of the touch-screen region of the mobile terminal according to a first embodiment of the present disclosure;

FIG. 3 is a schematic diagram of the upper and lower split screen of the mobile terminal according to an embodiment of the present disclosure;

FIG. 4 is the touch panel coordinate diagram according to an embodiment of the present disclosure;

FIG. 5 is a schematic diagram of the left and right split screen of the mobile terminal according to an embodiment of the present disclosure;

FIG. 6 is the touch panel coordinate diagram according to an embodiment of the present disclosure;

FIG. 7 is the touch panel coordinate diagram according to an embodiment of the present disclosure;

FIG. 8 is the touch panel coordinate diagram according to an embodiment of the present disclosure;

FIG. 9 is a schematic diagram of the touch control method according to an embodiment of the present disclosure;

FIG. 10 is a schematic diagram of the software architecture of the mobile terminal according to an embodiment of the present disclosure;

FIG. 11 is a schematic diagram of the mobile terminal according to an embodiment of the present disclosure;

FIG. 12 is a schematic diagram of the implementation of the present disclosure to determine the input event according to the device identification.

FIG. 13 is a flowchart of the input processing method according to an embodiment of the present disclosure;

FIG. 14 is a schematic diagram of the opening effect of the camera application of the mobile terminal of the upper and lower split screen with a rotation angle of 0 degrees using the input processing method according to an embodiment of the present disclosure;

FIG. 15 is a schematic diagram of the touch-screen region of the mobile terminal according to a second embodiment of the present disclosure;

FIG. 16 is a schematic diagram of the hardware structure of the user device according to an embodiment of the present disclosure.

### DETAILED DESCRIPTION

In order to have a clearer understanding of the technical characteristics, purpose and effect of the disclosure, the detailed implementation method of the disclosure is described with reference to the accompanying drawings.

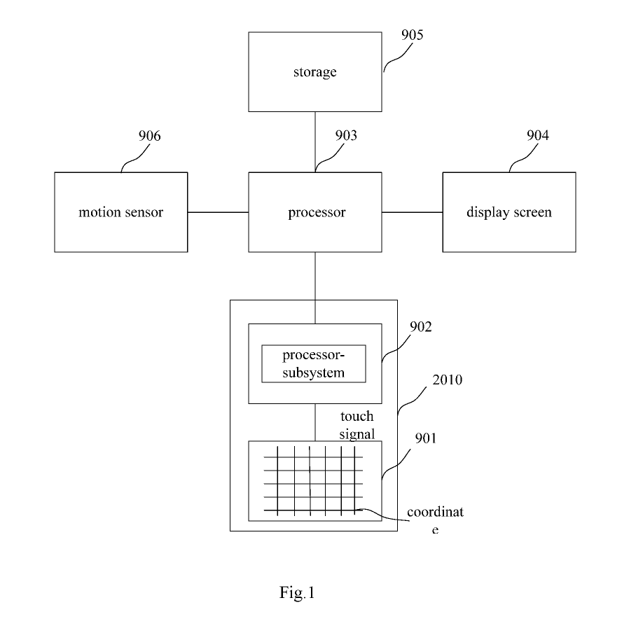

Referring to FIG. 1, the mobile terminal of the present disclosure includes an input device, processor 903 and screen 904. In an embodiment, the input device is touch screen 2010. Touch screen 2010 includes touch panel 901 and touch controller 902. In addition, the input device can be a non-touch input device (for example, an infrared input device).

Special touch controller 902 can be a single integrated circuit (ASIC), it can comprise one or more processor subsystem, the processor subsystem can comprise one or more of the ARM processor or other processors with similar functionality and performance thereof.

The touch controller 902 is mainly used to receive the touch signal generated in the touch panel 901 and, after processing, to transmit the processed signal to the mobile terminal's processor 903. For example, the processing includes converting the physical input signal from analog to digital, processing to obtain coordinates of the touch point, and processing to obtain the time duration of the touch, and so on.

The processor 903 receives the output of the touch controller 902, and then performs actions based on that output after processing. The actions include but not limited to, moving objects, such as a table or indicator, scrolling or panning, adjusting control settings, opening the file or document, viewing a menu, making selections, executing instructions, operating peripherals coupled to host equipment, answering phone calls, making phone calls, ending phone calls, changing the volume or audio settings, storing phone communication related information (address, number, has been answering the call, not answer the call), log on the computer or computer network, allowing authorized individuals to access a computer or computer network limited area, records the user profile associated with the user preferences of the computer desktop, allowing access to web content, start specific procedures, encrypt or decrypt, and so on.

The processor 903 also connects to the screen 904. The screen 904 is used to provide an UI to the user of the input device.

In some embodiments, the processor 903 can be a component that is separated from the touch controller 902. In other embodiments, the processor 903 can be an integrated component with the touch controller 902.

In an embodiment, the touch panel 901 has discrete capacitive sensors, resistive sensors, force sensors, optical sensors or similar sensors, and so on.

The touch panel 901 comprises an array of electrodes made of conductive material and arranged horizontally and vertically. For a single-point touch screen (which can only determine coordinates of a single-point touch) with an electrode array of M number of rows and N number of columns, touch controller 902 can use the self-capacitance scanning and, after respectively scanning M rows and N columns, can calculate and position the coordinates of the finger on the touch screen according to the signal of each row and each column, the number of scans being M+N.

For a multitouch touch screen (which can detect and analyze coordinates of multiple points, i.e., the multi-touch) with an electrode array of M number of rows and N number of columns, touch controller 902 uses multi-touch mutual-capacitance scanning to scan the intersections of rows and columns and, thus, the number of scans is M*N.

When the user's finger touches the touch panel, the touch panel generates a touch signal (for electrical signals) to the touch controller 902. The touch controller 902 gets the coordinates of the touch points by scanning. In one embodiment, the touch panel 901 of the touch screen 2010 is physically an independent coordinate positioning system, and the coordinates of the touch point of every touch are reported to the processor 903 and are converted by the processor 903 to pixel coordinates applicable to the display screen 904, so as to correctly identify input operations.

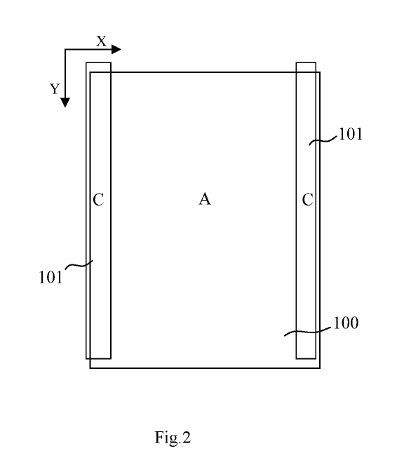

Referring to FIG. 2, the first embodiment of the disclosure relates to the area division of the touch panel. In the embodiment, in order to achieve accidental-touch prevention on the edge, and to provide a new way of interaction, the touch panel of the touch screen is divided into three regions, among which are the edge input area C 101, and the normal input area A 100.

It should be noted that FIG. 2 only shows a specific application scenario for the implementation of the embodiment. In practice, another specific application scenario for the implementation of the embodiment can be applied to mobile terminal without frames. In the mobile terminal without frames, because there are no frames, in contrast to the narrow frame ones, the edge input area of the no-frame terminal is to extend the area A outwards to the edge side of the terminal, and the edge side is the encircling side of the outside body of the terminal. It can be seen that the specific application scenario applicable to the embodiments of the disclosure is very extensive, and the edge input area is the area extending from the screen area to the side of the terminal edge. Implementation of the present disclosure is suitable for narrow frame or mobile terminals without fames, making full use of the external size of the mobile terminal, greatly expanding the mobile terminal screen size, and meeting the user demand for large screens. At the same time, the edge input operation is diversified by the gesture calibration operation of the edge input area.

In the embodiment of the present disclosure, the input operation in the area A is processed in accordance with the normal processing mode. For example, the application can be opened by clicking on an application icon in area A 100. For the input operation in the area C 101, it can be defined as the edge input processing mode. For example, it can be defined that the two-side sliding in the area C 101 is for the terminal acceleration, and so on.

In the embodiments of the present disclosure, the area C can be divided by a fixed format or by a custom division. Fixed partition is to set fixed-length and fixed-width area(s) as the area C 101. The area C 101 can comprise the part of the area on the left side of the touch panel and the part on the right, and its position is fixed on both sides of the touch panel, as shown in FIG. 1. Of course, the area C 101 can be partitioned only on one edge.

Custom division can configure the number, location, and size of the area C 101 by user's own definition. For example, based on settings set by the user or by the mobile terminal according to default requirements, the number, location, and size of the area C 101 can be adjusted. Generally, the basic graphic shape of the area C 101 is rectangular, and the position and size of the area C can be determined by inputting coordinates the two diagonal vertex of the shape.

In order to satisfy different users' usage habits of different applications, it can also set up multiple sets of area C settings in different application scenarios. For example, under the system desktop, the width of the area C on both sides is relatively narrow because of the large number of ICONS. However, when the camera icon is clicked into the camera app, the number, location and size of the area C can be set in this application scenario. In the case, without affecting the focus, the width of the area C can be set relatively large.

The embodiment of the present disclosure does not limit the division and setting of the area C.

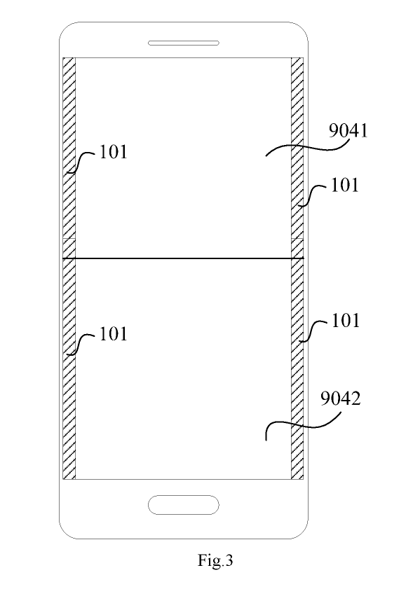

Referring to FIG. 3, the display screen 904 in the embodiment of the present disclosure is divided into a first display area 9041 and a second display area 9042. The first display area 9041 and the second display area 9042 may be an up-and-down split screen display, a left-and-right split screen display, or a large-and-small split screen display.

Specifically, the implementation method of split screen can be using the existing technology, which will not be described in detail herein.

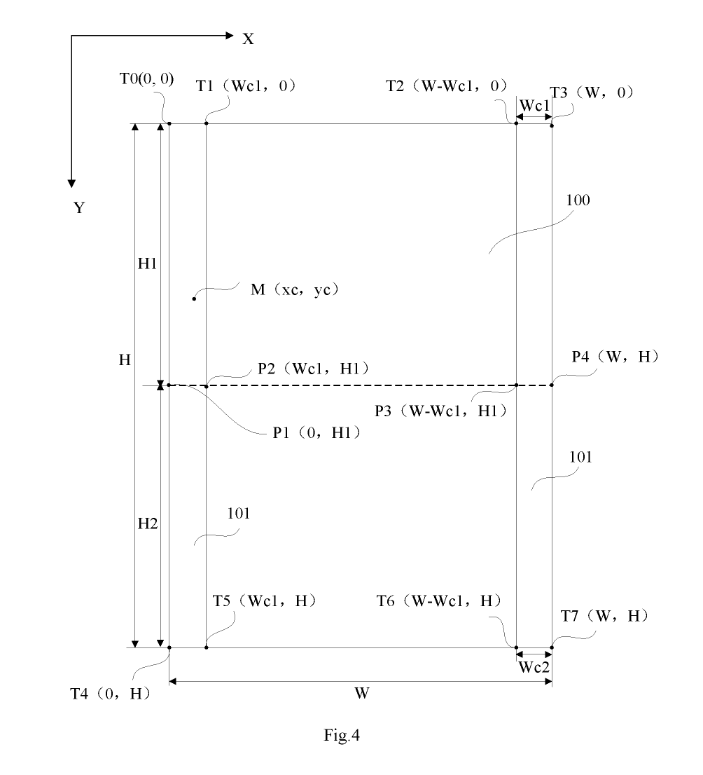

Referring to FIG. 4, T0 in the upper left corner of the touch panel is set as the origin point, and the coordinate value is (0,0). The lower right corner of the touch panel is T7 (W, H), where W is the width of the touch panel and H is the height of the touch panel.

In an embodiment of the present disclosure, as described above, the touch screen is divided into A and C areas, and A and C areas belong to the same coordinate system. When the touch panel of the mobile terminal is divided into multiple areas, the coordinates are also divided. For example, if the width of the touch panel is W, and the width of the area C is Wc, the touch points with coordinates within the area defined by T0, T1, T4 and T5, and/or with coordinates within the area defined by T2, T3, T6 and T7 are defined as edge touch points. The touch points with coordinates within the area defined by T1, T2, T5 and T6 are defined as normal touch points.

When the display screen 904 is divided into the first display area and the second display area, the partition of the corresponding touch panel's A and C areas is also changed adaptively. Specifically, referring to FIG. 4, after the split screen, the first edge touch area of the touch panel defined by T0, T1, P1, P2, and/or the second edge touch area defined by T2, T3, P3, P4 may constitute the edge touch area of the first display area. The fourth edge touch area defined by P1, P2, T4, T5, and/or the fifth edge touch area defined by P3, P4, T6, and T7 may constitute the edge touch area of the second display area.

Referring to FIG. 4, the edge touch area is divided corresponding to the division of the display screen 904. The H1 is the height of the first display area and H2 is the height of the second display area. The embodiment of the disclosure does not limit the size of H1 and H2, that is, the first display area and the second display area can be the same size or different size. The Wc1 is the width of the edge touch area of the first display area, and Wc2 is the width of the edge touch region of the second display area. Wc1 and Wc2 are equal in the embodiment of the disclosure.

In the embodiment of the disclosure, the first edge touch area, the second edge touch area, the third edge touch area and the fourth edge touch area may have corresponding touch gestures, respectively, as well as instructions corresponding to the touch gestures. For example, a sliding operation can be set up on the first edge touch area, and the corresponding instruction is for opening Application 1; a sliding operation can be set on the third edge touch area, and the corresponding instruction is for opening Application 2, and so on. It should be understood that, because, after the split screen, the first display area and the second display area are two independent areas for the display and control, different touch gestures and instructions can be set for the first edge touch area of the first display area and the third edge touch area of the second display area, or different touch gestures and instructions can be set for the second edge touch area of the first display area and the fourth edge touch area of the second display area. In addition, the touch gestures and instructions of the first display area and the second display area can be set to the same, so that the user can remember and operate.

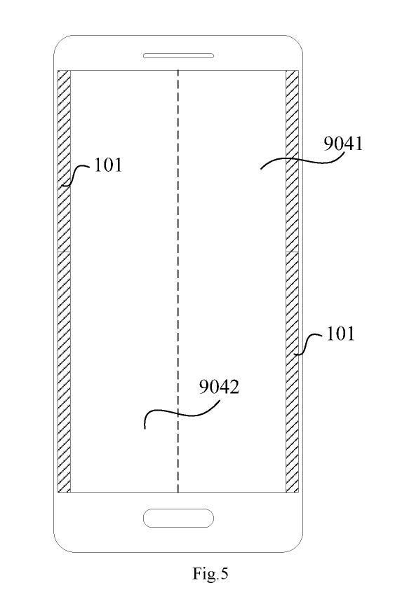

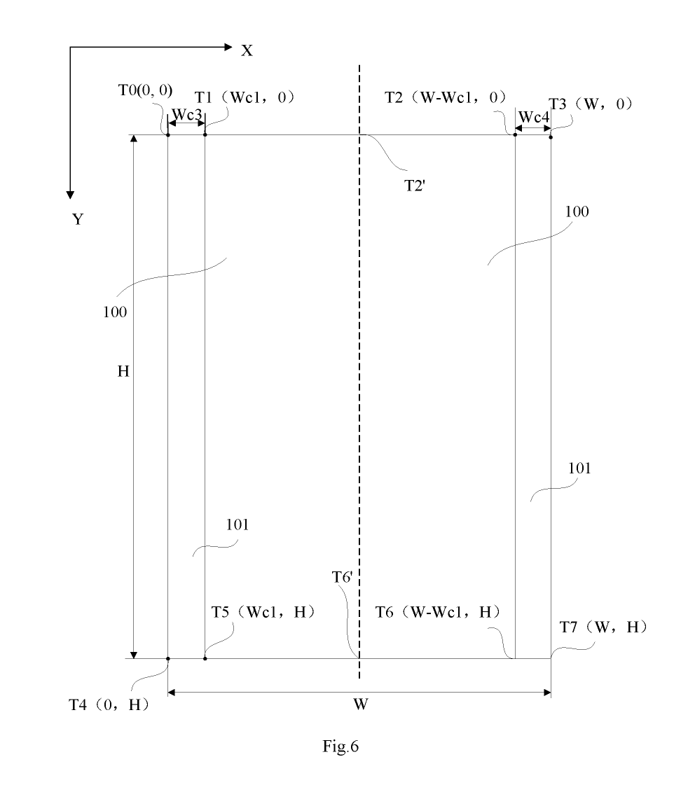

Referring to FIG. 5, when the display screen 904 adopts the left and right split screen, the two edge touch areas on the left and right sides are set for the convenience of operation, corresponding to the first display area and the second display area respectively. Specifically, referring to FIG. 6, the area defined by T0, T1, T4 and T5 on the touch panel is the edge touch area corresponding to the first display area. The area defined by T2, T3, T6 and T7 is the edge touch area corresponding to the second display area. Wc3 and Wc4 are respectively the width of the two edge touch areas.

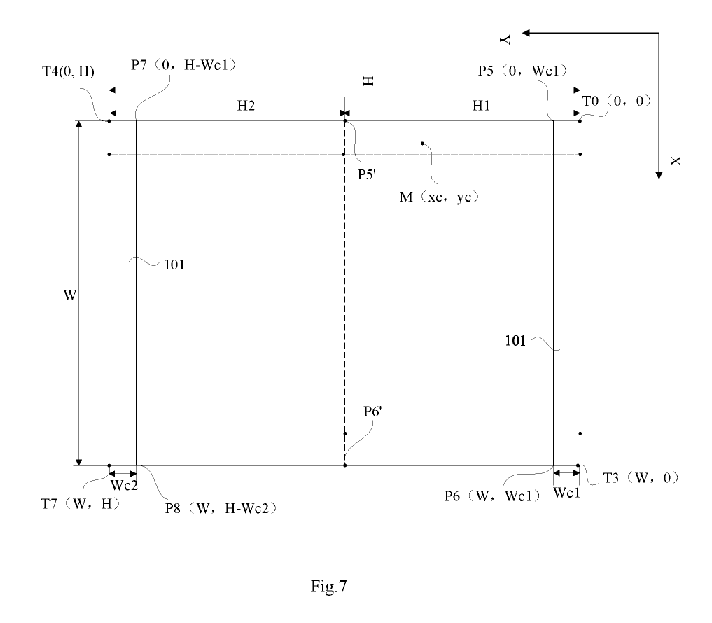

When the mobile terminal shown in FIG. 3 rotates 90 degrees clockwise, then the touch panel division method shown in FIG. 4 is transformed into the division method shown in FIG. 7. Specifically, the area defined by T0, T3, P5 and P6 is the edge touch area corresponding to the first display area (its width is Wc1). The area defined by T4, T7, P7 and P8 is the edge touch area corresponding to the second display area (its width is Wc2).

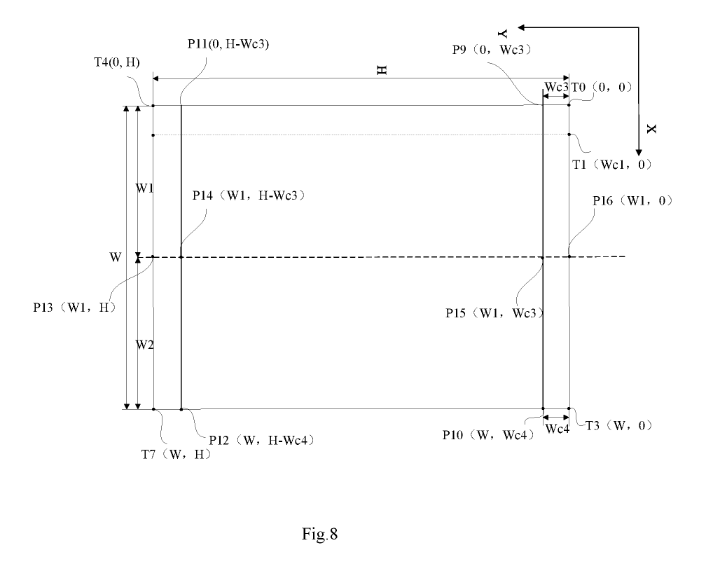

As shown in FIG. 5, the mobile terminal rotates 90 degrees clockwise, the divisions of the touch panel shown in FIG. 5 is transformed into the division method shown in FIG. 8. Specifically, the area defined by T0, P9, P15, P16, and/or the area defined by by T4, P11, P14, P13 are the edge touch area corresponding to the first display area (its width is Wc3, and height is W1). The area defined by T3, P10, P15, P16, and/or the area defined by T7, P12, P14, P13 are the edge touch area corresponding to the second display area (the width is Wc4 and the height is W2). It should be understood that Wc3 and Wc4 may be equal. The values of W1 and W2 may be set freely.

It should be understood that the partition of the edge touch area under the various split-screen modes of the embodiments of the present disclosure can be set according to the requirements, not limited to the division methods mentioned above.

Under the states of touch screen as shown in FIGS. 7-8, the touch screen coordinate system does not change, no matter which state in the above FIGS. 7-8 the mobile terminal touch screen is in or other states of rotation angle (the rotation state can be obtained by the motion detection sensor 906), when the touch panel 901 receives the touch signal, the touch controller 902 reports touch point coordinates in the same coordinate system, without paying attention to the rotation state of the touch screen. After the touch screen 2010 is rotated, the display screen 904 also have the corresponding rotation, the processor 903 can adaptatively convert the coordinates reported by the touch controller 902 to pixel coordinates for the display screen 904. Memory 905 may be stored with a corresponding relationship between the rotation angle and the conversion method, which is described later.

Referring to FIG. 9, based on the above mobile terminal, the touch control method of the embodiment of the disclosure comprises the following steps:

S100: Detecting a touch signal on the touch panel.

S101: Identifying a touch point according to the touch signal.

Specifically, when a finger or other object touches the touch panel to produce a touch gesture, the touch signal is generated. The touch controller detects the touch signal, and obtains physical coordinates of the touch point by scanning. In one embodiment of the disclosure, the coordinate system shown in FIG. 4 is adopted.

As mentioned above, the touch screen of the mobile terminal of the embodiment of the disclosure is divided into the edge touch area and the normal touch area and, therefore, the touch gestures in different areas are defined respectively. In an embodiment, the touch gestures in the normal touch area comprise: click, double click, slide, etc. Touch gestures of the edge touch area comprise: sliding up on the left-side edge, sliding down on the left-side edge, sliding up on the right-side edge, sliding down on the right-side edge, sliding up on both sides, sliding down on both sides, holding four corners of the phone, sliding back-and-forth on one side, grip, one hand grip, etc.

It should be understood that the “left” and “right” are relative, as used herein.

S102: Detecting the state of the split screen and the rotation angle of the mobile terminal, where the state of the split screen and the rotation angle may be determined according to the identified touch point, and determining whether the touch point is in the edge touch area or the normal touch area of the first display area, in the edge touch area or normal touch area of the second display area.

Specifically, the rotation angle of the mobile terminal can be detected by the motion sensor to detect the rotation angle of the mobile terminal. When the mobile terminal is rotated, the touch screen and display screen follow the rotation.

In the embodiment of the disclosure, the user can split the display screen manually to divide the touch screen into the first display area and the second display area. Thus, the split screen state can be obtained by the processor by detecting the relevant setting parameters of the mobile terminal.

The processor determines the area of the touch point based on the physical coordinates reported by the touch controller. In the embodiment of the disclosure, the storage has the coordinate range of each area., specifically, the coordinates of the relevant points shown in FIG. 4, FIG. 6, FIG. 7, and FIG. 8 can be stored. Thus, according to the stored coordinate ranges of the areas where the touch point is located, it can determine whether the touch point is in the edge touch area or normal touch area.

Referring to FIG. 4, under the up-and-down split screen mode, the coordinate range of the edge touch area of the first display area is: coordinates within the area defined by T0, T1, P1, P2, and/or coordinates within the area defined by T2, T3, P3, P4. The coordinate range of the normal touch area in the first display area is: the coordinates within the area defined by T1, T2, P3 and P2.

The coordinate range of the edge touch area of the second display area is: coordinates within the area defined by P1, P2, T4, T5, and/or coordinates within the area defined by P3, P4, T6, T7. The coordinate range of the normal touch area: coordinates within the area defined by P2, T5, T6 and P3. Referring to FIG. 7, under the up-and-down split screen mode, when touch screen rotates clockwise 90 degrees or rotates clockwise 270 degrees, the coordinate range of the edge touch area of the first display area is: coordinates within the area defined by T0, T3, P5 and P6. The coordinate range of the normal touch area in the first display area is: coordinates within the area defined by P5, P5′, P6′ and P6.

The coordinate range of the edge touch area of the second display area is: coordinates within the area defined by T4, T7, P7 and P8. The coordinate range of the normal touch area in the second display area is: coordinates within the area defined by P5′, P6′, P7 and P8.

Referring to FIG. 6, under the left-and-right split screen mode, the coordinate range of the edge touch area of the first display area is: coordinates within the area defined by T0, T1, T4 and T5. The coordinate range of the normal touch area in the first display area is: coordinates within the area defined by T2′, T2, T6 and T6′.

The coordinate range of the edge touch area of the second display area is: coordinates within the area defined by T0, T1, T4 and T5, and/or coordinates within the area defined by T2, T3, T6 and T7. The coordinate range of the normal touch area in the second display area is: coordinates within the area defined by T2′, T6′, T5 and T1.

Referring to FIG. 8, under the left-and-right split screen mode, when touch screen rotates clockwise 90 degrees or rotates 270 degrees clockwise, the coordinate range of the edge touch area of the first display area is: coordinates within the area defined by T0, P9, P15, P16, and/or coordinates within the area defined by T4, P11, P14, P13. The coordinate range of the normal touch area in the first display area is: coordinates within the area defined by P9, P15, P14 and P11.

The coordinate range of the edge touch area of the second display area is: coordinates within the area defined by T3, P10, P15, P16, and/or coordinates within the area defined by T7 has, P12, P14, P13. The coordinate range of the normal touch area of the area is: coordinates within the area defined by P16, P10, P12 and P14.

S103: Executing a corresponding instruction based on the determination.

Specifically, because the coordinates of the touch panel and the coordinates of the display screen are two independent coordinate systems, the physical coordinates of the touch panel need to be converted to the pixel coordinates of the display screen, so as to achieve the correct display touch point effect, the identification of touch gestures. Specifically, the conversion rules include the followings.

When the rotation angle is 0, for the touch point M, the coordinate reported by the touch controller is (xc, yc), and no conversion is required. That is, the coordinate of the display screen is also (xc, yc).

When the rotation angle is 90 degrees clockwise, for the touch point M, the coordinate reported by the touch controller is (xc, yc), then the converted coordinate is (yc, W−xc).

When the rotation angle is 180 degrees clockwise, for the touch point M, the coordinate reported by the touch controller is (xc, yc), then the converted coordinate is (W−xc, H-yc).

When the rotation angle is 270 degrees clockwise, for the touch point M, the coordinate reported by the touch controller is (xc, yc), then the converted coordinate is (H−yc, xc).

In the embodiments of the present disclosure, when under the split screen mode, a coordinate system will be separately established for each of the first display area and the second display area. And the reported coordinates are converted to the coordinates corresponding to the two coordinate systems proportionally. For example, the display screen of a mobile terminal is split up-and-down, and the first display area and a second display area of equal size. The reported coordinate (xc, yc) is scaled down by one half as (xc/2, yc/2). After the scaling down, it may be determined whether the coordinate is in the first display area or the second display area.

It should be understood that, in the embodiments of the disclosure, the coordinate conversion for the rotation should be carried out first, and then the coordinate conversion for the split screen is carried out, so as to ensure accuracy.

It should be understood that the above conversion rule is based on that the size of the display screen coordinate system is the same as the size of the touch panel coordinate system (for example, both are 1080×1920 pixels). If the display of the size of the coordinate system and the touch panel is not the same, after the above conversion, the coordinates may be further adjusted according to the coordinate system of the display screen. Specifically, the coordinate of the touch panel is multiplied by the corresponding conversion coefficient. The conversion factor is the ratio of the size of the display screen to the size of the touch panel. For example, if the touch panel is 720×1280, and the display screen is 1080×1920, the ratio of the display screen and touch panel is 1.5. Therefore, the horizontal coordinate and the vertical coordinate of the reported physical coordinates of the touch panel are multiplied by 1.5 respectively, i.e., the original coordinate (xc, yc) may be converted to screen coordinate as (1.5×xc, 1.5×yc), or (1.5×yc, 1.5×W−xc), and so on.

After the coordinate conversion and adjustment, the accurate display can be realized, the correct touch gesture is identified, and the instruction corresponding to the touch gesture is executed. In the embodiments of the disclosure, the touch gestures correspond to the instructions one-to-one, and are stored in the memory.

The touch control method of the embodiment of the disclosure can be realized edge touch area according to the rotation of the touch screen and display state of split screen, the corresponding conversion to better adapt to the user's operation, improving the user experience.

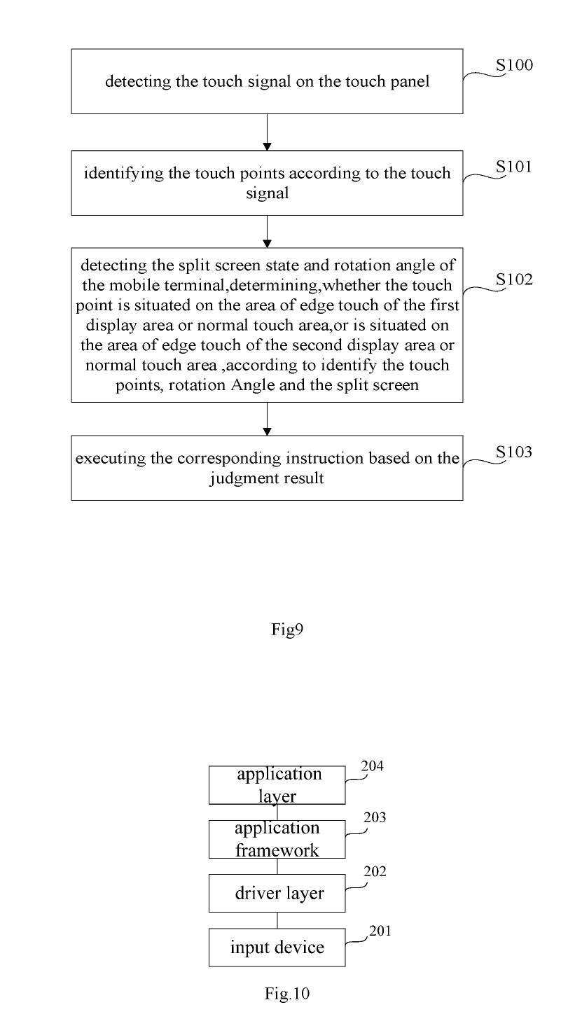

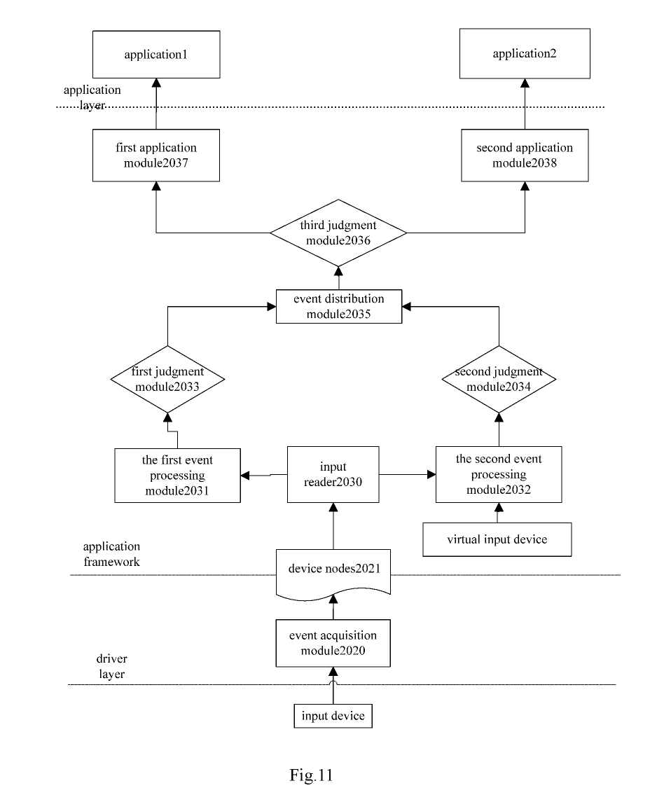

Referring to FIG.10, a schematic diagram of the software architecture of the mobile terminal of an embodiment. The software architecture of the mobile terminal of the embodiment of the disclosure comprises: input device 201, driver layer 202, application framework layer 203 and application layer 204. Further, the driver layer 202, the application framework layer 203 and the application layer 204 may be performed by the processor 903. In an embodiment, the input device 201 is a touch screen that includes a touch panel and a touch controller.

Input device 201 receives the input operation of the user, converts a physical input to a touch signal, and passes the touch signal to the driver layer 202. The driver layer 202 analyzes the location of the physical input to obtain specific parameters such as coordinate, duration of a touch point, and transmit the parameters to the application framework layer 203. Communication between the application framework layer 203 and drive 202 can be done by the corresponding interface. Application framework layer 203 receives the parameters reported by the driver layer 202, which analyzes the parameters to determine whether it is an edge input event and a normal input event, and sends the valid input to a specific application of the application layer 204, in order to meet the requirement of the application layer 204 to execute different input operation instructions based on the different inputs.

Referring to FIG. 11, it shows the structure diagram of the mobile terminal of an embodiment of the present disclosure. In an embodiment of the disclosure, the input device comprises the touch screen 2010 mentioned above. Driver layer 202 includes event acquisition module 2020. Device node 2021 is set between the driver layer 202 and the application framework layer 203. Application framework layer 203 including input reader 2030, the first event processing module 2031, the second event processing module 2032, the first judgment module 2033, the second judgment module 2034, and event distribution modules 2035, third judgment module 2036, the first application module 2037, the second application module 2038, and so on.

The driver layer 202 comprises the event acquisition module 2010, which is configured to obtain input events generated by the user through input device 201, for example, input operation events through the touch screen. In the embodiments of the disclosure, the input events comprise: normal input events (area A input events) and edge input events (input events in area C). Normal input events may include: click, double click, slide, and other input operations in area A. Edge input events includes inputs on the edge of the area C: sliding up on the left-side edge, sliding down on the left-side edge, sliding up on the right-side edge, sliding down on the right-side edge, sliding up on both sides, sliding down on both sides, holding four corners of the phone, sliding back-and-forth on one side, grip, one hand grip, etc.

In addition, the event acquisition module 2010 is configured to obtain the coordinates, duration, and other related parameters of the touch points of the input operation. If A protocol is used to report the input event, the event acquisition module 2010 is also configured to assign a number (ID) to each touch point to distinguish the fingers. Therefore, if A protocol is used to report the input event, the reported data includes the coordinates of the touch point, duration and other parameters, as well as the number of the touch points.

The device node(s) 2011 is disposed between the driver layer 202 and the input reader 2030, and is configured to notify input events to the input reader 2030 of the application framework layer 203.

Input reader 2030 is configured to traverse all device nodes, obtain and report input events. If the driver layer 202 uses the B protocol to report the input event, the input reader 2030 is also configured to assign a number (ID) to each touch point to distinguish the finger. In the embodiments of the disclosure, the input reader 2030 is also configured to store all the parameters of the touch point (coordinate, duration, number, etc.).

In the embodiments of the present disclosure, in order to facilitate the use of the application layer 204 to distinguish different input events in response, each input event creates an input device object with a device ID. In an embodiment, the first input device object can be created for normal input events with a first identifier. The first input device object corresponds to the actual hardware touch screen.

In addition, the application framework layer 203 also comprises a second input device object 2031. The second input device object 2031 (for example, the edge input device, FIT device) is a virtual device, or an empty device, with a second identifier configured to correspond to the edge input event. It should be understood that the edge input event can also correspond to the first input device object with the first identifier, and the normal control event corresponds to the second input device object with the second identifier.

The first event processing module 2031 is configured to handle input events reported by the input reader 2030, for example, the coordinates of the touch points.

The second event processing module 2032 is configured to handle input events reported by the input reader 2030, for example, the coordinates of the touch points.

The first judgment module 2033 is configured to determine whether an event is an edge input event based on the coordinate value (X value). If not, the event is uploaded to the event distribution module 2035.

The second judgment module 2034 is configured to determine whether an event is an edge input event based on the coordinate value (X value), and if it is, the event is transmitted to the event distribution module 2035.

It should be understood that, in the embodiments of the disclosure, the first judgment module 2033 and the second judgment module 2033, when making the determination, do not need to pay attention to split screen and rotation, only need to determine whether the coordinates of the touch point fall into the coordinate range of the edge touch area of the above mentioned first display area and/or the second display area.

The event distribution module 2035 is configured to report the edge input events and/or area A input events to the third judgment module 2036. In an embodiment, the channel for reporting the edge input event is different from the channel used for reporting the input event in area A. The edge input events are reported using a dedicated channel.

In addition, the event distribution module 2035 is configured to obtain the current state of the mobile terminal, and the reported coordinates are converted and adjusted according to the current state.

In the embodiment of the disclosure, the current state includes the rotation angle and the split screen state. The current state of the mobile terminal is obtained according to the detection result of the motion sensor. The screen state is obtained according to the relevant setting parameters of the detected mobile terminal. The rotation angle includes: 0 degree, clockwise 90 degree, clockwise 180 degree, clockwise 270 degree, etc. It should be understood that if the counterclockwise rotation is counterclockwise, the counterclockwise 90 degrees is the same as the clockwise 270 degrees, and the counterclockwise 180 degrees is the same as the clockwise 180 degrees, and the counterclockwise 270 degrees is the same as the clockwise 90 degrees. Split screen state includes: left-and-right split screen, and up-and-down split screen.

In the embodiments of the present disclosure, when under the split screen mode, a coordinate system will be separately established for each of the first display area and the second display area. And the reported coordinates are converted to the coordinates corresponding to the two coordinate systems proportionally. For example, the display screen of a mobile terminal is split up-and-down, and the first display area and a second display area of equal size. The reported coordinate (xc, yc) is scaled down by one half as (xc/2, yc/2). After the scaling down, it may be determined whether the coordinate is in the first display area or the second display area.

For the rotation of a certain angle, the coordinate conversion method can be referred to the above description.

It should be understood that, in the embodiments of the disclosure, the coordinate conversion of the rotation should be carried out first, and then the coordinate conversion of the split screen can be carried out to ensure the accuracy.

In an embodiment, the event dispatch module 2036 is implemented by function inputdispatcher::dispatchmotion( )

The third judgment module 2036 is configured to, according to the device identifier (ID), determine whether the event is the edge input event, and if it is, then report to the first application module 2037, otherwise report to the second application module 2038.

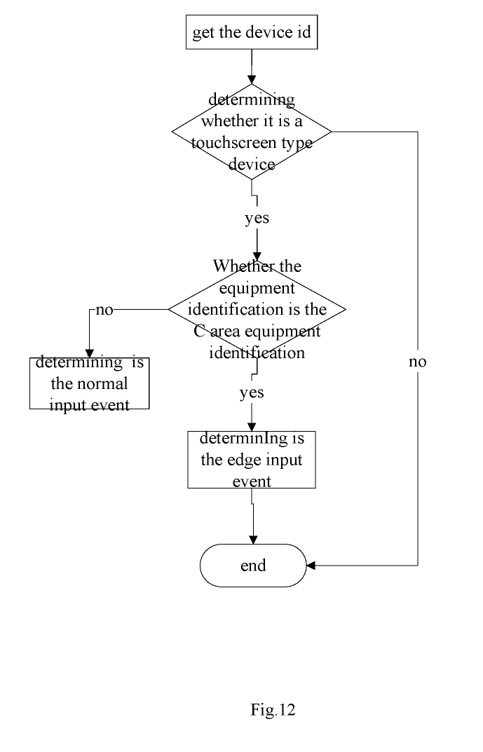

Referring to FIG.12, specifically, when the third judgment module 2036 is making the determination, it first obtains the device identifier, and determines whether it is a touch screen type device according to the device identifier. If so, it further determines whether the device identifier is a device identifier for the area C equipment identifier, i.e., the identifier of the second input device object and, if so, determines that the event is the edge input event; if not, it is determined as a normal input event. It should be understood that, after determining whether it is a touch screen type device, it can further determine whether the device identifier is an area A device identifier, i.e., the device identifier of the first input device object. If yes, the event can be determined as the normal input events and, if not, the event can be determined as the edge input event.

In the implementation of the disclosure, the first application module 2037 is configured to process input events related to area A input. Specifically, the processing may include: according to the coordinate, duration, number of the touch point of the input operation, performing processing and identifying, and the identification result is reported to the application layer. The second application module 2038 is configured to process input events related to area C input. Specifically, the processing may include: according to the coordinate, duration, number of the touch point of the input operation, performing processing and identifying, and the identification result is reported to the application layer. For example, based on the coordinates, duration, and number of the touch point, it can be identified whether the input operation is click or slide on area A, or a single-side back-and-forth slide on area C, and so on.

Application layer 204 comprises camera, gallery, lock screen, etc. (application 1, application 2, . . . ). The input operation in the embodiments of the disclosure can at the application level and the system level, and the system level gesture processing is also classified as the application layer. The application level is the control of the application, for example, opening, closing, volume control, etc. System level is the control of mobile terminal, for example, powering up, accelerating, switching between applications, global return, etc. The application layer can process the input event in area C by registering the listener of the area C event, or process the input event in area A by registering the listener of the area A event.

In an embodiment, the mobile terminal sets and stores instructions corresponding to different input operations, which comprises instructions corresponding to the edge input operation and instructions corresponding to the normal input operation. The application layer receives the recognition result of the reported edge input event, that is, the corresponding instruction is invoked according to the edge input operation to respond to the edge input operation. The application layer receives the recognition result of the reported normal input event, that is, the corresponding instruction is invoked according to the normal input operation to respond to the normal input operation.

It should be understood that the input events of the embodiments of the disclosure comprise the input operation only in area A, the input operation only in area C, and the input operation in area A and area C. Therefore, the instructions also comprise instructions that corresponding to these three types of input events. The disclosure implementation example can realize using the combination of the area A and the area C input operation to control the mobile terminal. For example, the input operation is a click on area A and a corresponding position of area C at the same time, the corresponding instruction is for closing an application. Therefore, by the input operation of clicking the area A and the corresponding position of the area C at the same time, it can realize closing the application.

The embodiment of the invention of the mobile terminal, which can realize the conversion edge touch area according to the rotation and split screen state of the touch screen, so as to better adapt to the user's operation and improve the user experience. On the other hand, because the operation of area A and the operation of area C can only be distinguished at the application framework layer, and the virtual devices are also established at the application framework layer, it can avoid the reliance on hardware when distinguishing between area A and area C in the driver layer. By setting the touch point number, the fingers can be distinguished, which is compatible with A protocol and B protocol. Further, because functions such as the input reader 2030, the first event processing module 2031, the second event processing module 2032, the first judgment module 2033, the second judgment module 2034, and event distribution modules 2035, third judgment module 2036, the first application module 2037, and the second application module 2038 can be integrated into the operating system of the mobile terminal, applicable to different hardware, different kinds of mobile terminals, and having good portability. The input reader automatically saves all parameters of a touch point (coordinates, numbers, etc., of the touch point) to facilitate the subsequent judgment of edge input (for example, FIT).

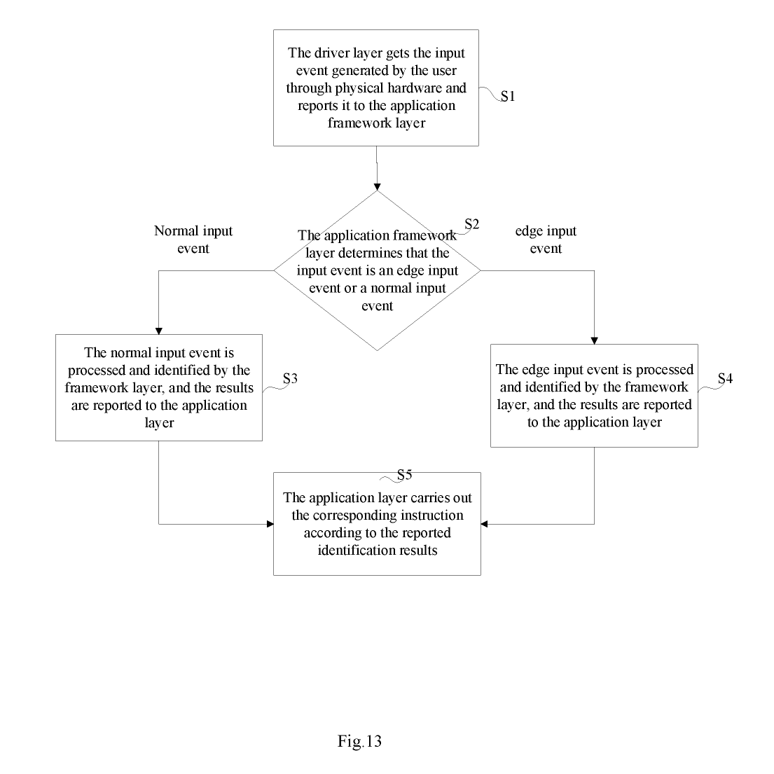

Referring to FIG. 13, a flow chart of the input processing method for the embodiment of the disclosure, the method includes the following steps:

S1, the driver layer gets the input event generated by the user through the input device and reports it to the application framework layer.

Specifically, the input device receives the user's input operation (i.e., input event), converts the physical input to the electrical signal, and sends the electrical signal to the driver layer. In the embodiment of the disclosure, the input event comprises the area A input event and the area C input event. The area A input events in include: click, double click, slide, etc., in area A. The area C input events include input operations in the area C such as sliding up on the left-side edge, sliding down on the left-side edge, sliding up on the right-side edge, sliding down on the right-side edge, sliding up on both sides, sliding down on both sides, holding four corners of the phone, sliding back-and-forth on one side, grip, one hand grip, etc.

The driving layer analyzes the input location according to the received electrical signals, and obtains related parameters such as the specific coordinates and duration of the touch points. The related parameters are reported to the application framework layer.

In addition, if the driver layer adopts the A protocol to report the input event, the step S1 also comprises: assigning each touch point a number (ID) to distinguish the fingers.

Thus, if the driver layer adopts A protocol to input events, the report data includes the related parameters, and the number of touch point.

S2, the application framework layer determines whether the input event is an edge input event or a normal input event. When the input event is a normal input event, the step S3 is executed and, when the input event is the edge input event, the step S4 is executed.

When the driver layer adopts the B protocol to report the input event, then step S2 also includes: assigning a number (ID) for each touch point to distinguish the finger for each touch point, and storing the all parameters of the touch point (coordinate, duration, number, etc.).

It should be understood that, during determination, the application framework layer does not need to pay attention to split screen or rotation, only needs to determine whether the coordinates of the touch point fall into the coordinate range of the edge touch area of the above mentioned first display area and/or the second display area.

Thus, the embodiments of the disclosure can distinguish fingers by setting the touch point number, and is compatible with both A protocol and B protocol. All the parameters of the touch point (coordinates, Numbers, etc.) of the touch points are stored, which can be used to subsequently determine the edge input (for example, FIT).

In an embodiment, the channel for reporting the edge input event is different from the channel used for reporting the input event in area A. The edge input events are reported using a dedicated channel.

S3, the normal input event is processed and identified by the application framework layer, and the identified results are reported to the application layer.

S4, the edge input event is processed and identified by the application framework layer, and the identified results are reported to the application layer.

Specifically, the processing and identifying includes: according to the coordinate, duration, number of the touch point of the input operation, performing processing and identifying to determine the input operation. For example, based on the coordinates, duration, and number of the touch point, it can be identified whether the input operation is click or slide on area A, or a single-side back-and-forth slide on area C, and so on.

S5, the application layer performs the corresponding instruction according to the reported identification results.

Specifically, the application layer comprises applications such as camera, gallery, lock screen, etc. The input operation in the embodiments of the disclosure can at the application level and the system level, and the system level gesture processing is also classified as the application layer. The application level is the control of the application, for example, opening, closing, volume control, etc. System level is the control of mobile terminal, for example, powering up, accelerating, switching between applications, global return, etc.

In an embodiment, the mobile terminal sets and stores instructions corresponding to different input operations, which comprises instructions corresponding to the edge input operation and instructions corresponding to the normal input operation. The application layer receives the recognition result of the reported edge input event, that is, the corresponding instruction is invoked according to the edge input operation to respond to the edge input operation. The application layer receives the recognition result of the reported normal input event, that is, the corresponding instruction is invoked according to the normal input operation to respond to the normal input operation.

It should be understood that the input events of the embodiments of the disclosure comprise the input operation only in area A, the input operation only in area C, and the input operation in area A and area C. Therefore, the instructions also comprise instructions that corresponding to these three types of input events. The disclosure implementation example can realize using the combination of the area A and the area C input operation to control the mobile terminal. For example, the input operation is a click on area A and a corresponding position of area C at the same time, the corresponding instruction is for closing an application. Therefore, by the input operation of clicking the area A and the corresponding position of the area C at the same time, it can realize closing the application.

In an embodiment, the input processing method of the embodiment of the disclosure also include the followings.

S11, creating an input device object with a device ID for each input event.

Specifically, in an embodiment, the first input device object can be created for normal input events with the first identification. The first input device object corresponds to the input device, the touch screen. The application framework layer sets a second input device object. The second input device object (for example, FIT device) is a virtual device, or an empty device, with a second ID that corresponds to the edge input event. It should be understood that the edge input event may also correspond to the first input device object with the first identity, and the normal control event corresponds to the second input device object with the second id.

In an embodiment, the input processing method of the embodiment of the disclosure also includes the followings.

S21, based on the rotation angle and split screen of the mobile terminal, the application frame layer can report the converted and adjusted coordinates reported.

The concrete implementation of the conversion and adjustment of coordinates is described above, which is not repeated here.

In an embodiment, Step S21 can be implemented by function inputdispatcher::dispatchmotion( )

S22, according to the device ID, determine whether the input event is an edge input event. If yes, then the step S3 is executed, and if it is not, then the step S4 is executed.

Specifically, refer to FIG. 11, when determining whether the input event is the edge input event based on the device ID, the device ID is first obtained and, according to the device ID, it can determine whether it is a touch screen type device. If so, it further determines whether the device identifier is a device identifier for the area C equipment identifier, i.e., the identifier of the second input device object and, if so, it determines that the event is the edge input event; if not, it is determined as a normal input event. It should be understood that, after determining whether it is a touch screen type device, it can further determine whether the device identifier is an area A device identifier, i.e., the device identifier of the first input device object. If yes, the event can be determined as the normal input events and, if not, the event can be determined as the edge input event.

The input processing method of the implementation of the disclosure can realize the conversion edge touch area according to the rotation and split screen state of the touch screen, so as to better adapt to the user's operation and improve the user experience. On the other hand, because the operation of area A and the operation of area C can only be distinguished at the application framework layer, and the virtual devices are also established at the application framework layer, it can avoid the reliance on hardware when distinguishing between area A and area C in the driver layer. By setting the touch point number, the fingers can be distinguished, which is compatible with A protocol and B protocol. Further, because functions can be integrated into the operating system of the mobile terminal, applicable to different hardware, different kinds of mobile terminals, and having good portability. The input reader automatically saves all parameters of a touch point (coordinates, numbers, etc., of the touch point) to facilitate the subsequent judgment of edge input (for example, FIT).

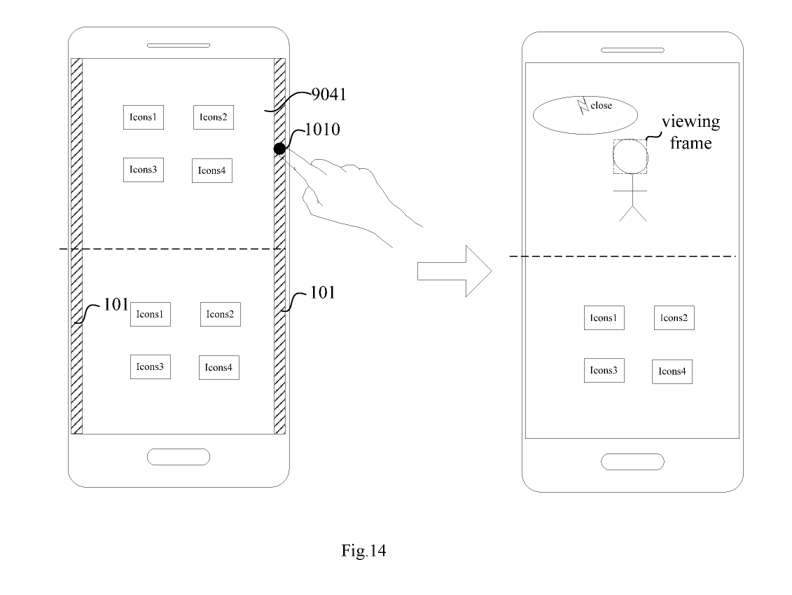

Referring to FIG. 14, using the input processing method of the embodiments of the disclosure, the effect of the camera application of the mobile terminal of the up-and-down split screen mode is shown. In FIG. 14, the left side figure shows the main interface of the mobile terminal, and the area 1010 is a preset touch point for input operation realizing the opening the camera function in the edge input area (area C 101). Specifically, clicking area 1010 can enable the camera to be turned on. In the mobile terminal, there stored an instruction: corresponding to the input operation of clicking area 1010, opening the camera.

When need to use a camera, the user clicks the area 1010 on the touch screen, and the driver layer gets the input event and reports it to the application framework layer. The application framework layer can determine the input event as the edge input event based on the coordinates of the touch point. The edge input event is processed and identified by the application framework layer, and the input operation is identified as the click area 1010 according to the touch point coordinates, duration and encoding. The application framework layer reports the result to the application layer, and the application layer executes the instruction to turn on the camera.

It should be understood, in FIG. 14, after the camera function is started, the area C is not shown, but it still exists. Or, according to the present disclosure implementation example of the above description of area C, after opening the camera, area C width can be adjusted relatively wider, etc., which can be understood by those skilled in the art.

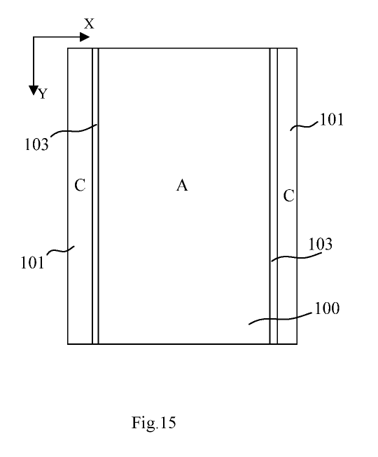

FIG. 15 is a schematic diagram of the touch screen of the mobile terminal for another embodiment of the disclosure. In the implementation, a transition area 103 (area T) is added to the edge of the touch panel of the mobile terminal to prevent the falling accuracy when the user, during the input process, deviate from the stating input area.

In the embodiment, when the input event starts from the area C, it is still considered that the sliding is the edge gesture. When the input event starts from area C and deviates to area A, it is considered that the edge gesture is complete and the normal input event is started. When the input event starts from the area T or area A, and then slides to any area of the touch panel, it is considered that this slide is a normal input event.

The input event reporting process of the implementation is same as interactive control method of the implementation mentioned in the above example, and the difference only lies in that: when the application framework layer performs processing and identifying of the edge input event, it needs to make determination according to the above three kinds of circumstances, so as to determine the accurate input events. For example, the application framework layer determines, according to the touch point of a certain reported input event, that the input event starts from the area C, and deviates to area A (i.e., the coordinate of the touch point at the beginning of the input is located in the area C, while in the process of input the coordinate of a touch point is located in the area A). The first judgment module and the second judgment module determine, according to the coordinates, that the input event is an edge input event, and the edge input event is completed, and a normal input event begins. The driver layer starts the report of the next input event.

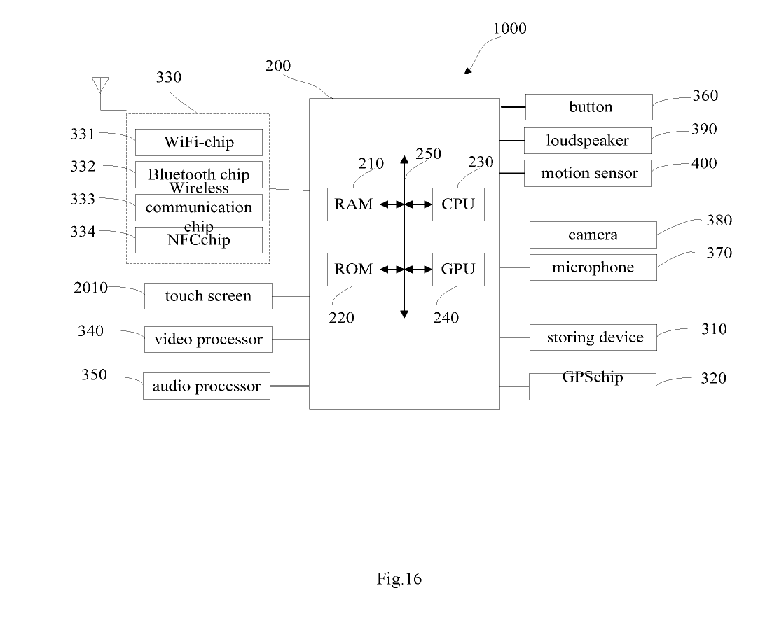

Accordingly, the embodiment of the disclosure also provides a user device, as shown in FIG. 16 of the hardware schematic diagram. Refer to FIG. 16, user equipment 1000 includes touch screen 2010, the controller 200, storage device 310, GPS chip 320, communication device 330, audio processor, 350, video processor 340, button 360, microphone 370, camera 380, speaker 390, and motion sensor 906.

Touch screen 2010 can be partitioned as area A and area C, or area A, area C, and area T. Touch screen 2010 can be implemented for various types of displays, such as LCD (liquid crystal display), OLED (organic light emitting diode) display and PDP (plasma display panel). Touch screen 2010 can include drive circuits, which can be implemented as, for example, a-si TFT, LTPS (low temperature polysilicon) TFT and OTFT (organic TFT), and backlight units.

At the same time, the touch screen 2010 comprises touch sensors for touch gestures for sensing users. Touch sensors can be implemented for various types of sensors, such as capacitance types, resistance types, or piezoelectric types. Capacitance type by when the user part of the body (for example, a user's finger) to touch a conductive material coated on the surface of touch screen when the surface of the sensing inspired by the user's body of micro electric current touch coordinates calculation. Including two electrode plates, depending on the type of resistance touch screen, and when users touch the screen through the sensor when the touch points of the upper and the lower contact flow of electrical current, to calculate the touch coordinate values. In addition, when the user device 1000 supports pen input, the touch screen 2010 can be used to detect user gestures for input devices such as pens, except for user's fingers. When the input device is including a coil of handwritten pen stylus (pen), the user equipment can include 1000 used for sensing the magnetic field of magnetic sensor (not shown), described in the magnetic field of magnetic sensor according to the coil inside the pen close degree. In addition to the sensing touch gestures, the user device 1000 can also sense the proximity gesture that the stylus hover over the user's device 1000.

The storage device 310 can store the various programs and data required for the operation of user device 1000. For example, storage device 310 can store programs and data for the various screens that will be displayed on various areas (for example, area A, area C).

The controller 200 displays content in each area of the touch screen 2010 by using programs and data stored in the storage device 310.

The controller 200 includes RAM 210, ROM 220, CPU 230, GPU (graphics processing unit) 240 and bus 250. RAM 210, ROM 220, CPU 230 and GPU 240 can be connected to each other via bus 250.

CPU (Central Processing Unit) 230 accesses the storage device 310 and use the operating system (OS) stored in the storage device 310. Also, CPU 230 performs various operations by using various programs, content, and data stored in the storage device 310.

ROM 220 storage for the system startup instruction set. When the open instruction is inputted and the power is provided, the CPU 230 according to instruction set stored in ROM 220 will copy the OS stored in the storage device 310 to the RAM 210, and run the OS to start the system. When starting is finished, CPU 230 copies various procedures stored in the storage unit 310 to the RAM and executes from the RAM 210copied program to perform various operations. Specifically, the GPU 240 can be through the use of calculator (not shown) and the renderer (not shown) generated including various objects such as ICONS, images and text of the screen. Calculator such as coordinates, format, size, and color of eigenvalues, which respectively according to the layout of the screen with color markers.

GPS chip 320 from GPS (global positioning system (GPS) satellite receiving GPS signal unit, and calculated the current position of the user equipment 1000.When we use the navigator or when requesting the user's current location, the controller 200 can through the use of GPS chip 320 calculate the user's location.

Communication device 330 is according to the various types of communication methods and various types of external equipment to perform communication unit. Communication device 330 comprises WiFi chip 331, bluetooth chip 332, wireless communication chip 333 and NFC chip 334. Controller 200 executes communication with various kinds of peripheral equipment through the use of communication 330.

Wi-fi chip 331 and bluetooth chip 332 respectively according to the WiFi method and bluetooth communication. When using wi-fi chip 331 or bluetooth chip 332, such as service set identifier (service set identifier, SSID) and session key such various connection information can be send first, by using the connection information connection communication, and can send and receive all kinds of information. wireless communication chip 333 is based on, such as IEEE, Zigbee, 3G (third generation), 3GPP (third generation cooperation projects) and LTE (long-term evolution) such chips of various kinds of communication standards. NFC chip 334 is according to the use of various RFID frequency band width of 13.56 MHZ bandwidth NFC (near field communication) method for operation of chip, all kinds of RFID frequency band width, such as 135000 hz, 13.56 MHZ, 135000 MHZ, 860-960 MHZ and 2.45 GHZ.

The video processor 340 is a unit that processes video data included in content received through the communicator 330 or content stored in the storage device 310. The video processor 340 may perform various image processing for video data such as decoding, scaling, noise filtering, frame rate conversion, and resolution conversion

The audio processor 350 is a unit that processes audio data included in content received through the communicator 330 or stored in the storage device 310. The audio processor 350 can perform various kinds of processing on audio data such as decoding, amplification, and noise filtering.

The controller 200 may reproduce the corresponding content by driving the video processor 340 and the audio processor 350 when the reproduction program is run for the multimedia content.

The speaker output 390 generated audio data in the audio processor 350.

Button 360 can be various types of buttons, such as mechanical button or as user equipment 1000 outside the main body of the front, sides or rear areas formed on the touch pad or touch the wheel.

Microphone 370 is the unit that receives user voice or other sounds and transforms them into audio data. The controller 200 can be used during the call process by using a microphone 370 to input the user's voice, or convert them to audio data and stored in the storage device 310.

The camera 380 is a unit that captures a still image or a video image based on the user's control. Camera 380 can be achieved for multiple units, such as front and back cameras. As described below, the camera 380 can be used as a device for capturing user images in a demonstration embodiment that tracks the user's gaze.

When providing camera 380 and microphone 370, the controller 200 can perform control actions based on the user's voice input from the microphone 370 or the user action identified by the camera 380. Therefore, user device 1000 can be operated in the action control mode or voice control mode. When operating in the action control mode, the controller 200 takes the user by activating the camera 380, tracking the change of user actions, and performing the corresponding operation. When operating in voice control mode, the controller can be operated in speech recognition mode to analyze 200 370 through a microphone input speech and voice executive function according to the analysis of the users.

In the user device 1000, which supports action control mode or voice control mode, speech recognition technology or action recognition technology is used in the above embodiments. For example, when a user performs like choose the tag on the homepage screen object of the action or the object corresponding to the voice instruction, select the corresponding object can be determined and can be performed with the object matching control operation.

The motion sensor 906 is the mobile unit of the main body for sensing user device 1000. User device 1000 can be rotated or tilted in various directions. Motion sensor 906 can sense, through the use of one or more of sensors such as magnetic sensor, gyroscope sensor and acceleration sensor, movement characteristics such as rotating direction, angle and slope. It should be understood that when the user's device is rotated, the corresponding touch screen is also rotated at the same rotation angle as the user device.

Although not shown in FIG. 16, according to a demonstrative example, the user equipment 1000 may further include a USB port capable of being connected to the USB connector, various input ports for connecting various external components such as headphones, a mouse, a LAN, and a DMB chip for receiving and processing DMB (Digital Multimedia Broadcasting) signals. And various other sensors.

As mentioned above, the storage device 310 can store various programs.

Based on the user device shown in FIG. 16, in the embodiments of the present disclosure, the touch screen is configured to detect the touch signal generated on the touch panel and to detect the touch point based on the touch signal.

The motion sensor is configured to detect the rotation angle of the user's device.

The processor includes a driver module, an application framework module, and an application module.

The driver module is configured to obtain input events based on the touch signal and report to the application framework module;

The application framework module is configured to, according to the touch point location of the reported input event, rotation angle, and split screen, determine whether the touch point is situated in the edge touch area or the normal touch area of the first display area, or in in the edge touch area or the normal touch area of the second display area, and perform identification based on the determination result and report the identification result to the application module.

The application module is configured to execute a corresponding instruction based on the reported identification result.

It should be understood that the working principles and details of each module of the user device of the embodiment are the same as described in the above embodiments, which is not repeated here.

The touch control method, the user equipment, input processing method, the mobile terminal and intelligent terminal, according to the embodiments of the disclosure, can realize the conversion edge touch area according to the rotation and split screen state of the touch screen, so as to better adapt to the user's operation and improve the user experience. On the other hand, because the operation of area A and the operation of area C can only be distinguished at the application framework layer, and the virtual devices are also established at the application framework layer, it can avoid the reliance on hardware when distinguishing between area A and area C in the driver layer. By setting the touch point number, the fingers can be distinguished, which is compatible with A protocol and B protocol. Further, because functions can be integrated into the operating system of the mobile terminal, applicable to different hardware, different kinds of mobile terminals, and having good portability. The input reader automatically saves all parameters of a touch point (coordinates, numbers, etc., of the touch point) to facilitate the subsequent judgment of edge input (for example, FIT).

It should be understood that the terminal of the embodiments of the disclosure can be implemented in various forms. For example, the terminal described in the present disclosure can include mobile devices such as intelligent terminals with communication function, mobile phones, mobile phones, smart phones, laptops, digital broadcasting receiver, PDA (personal digital assistant), PAD (tablets), PMP (portable multimedia player), navigation devices and so on, and other fixed equipment such as digital TV and desktop computers, etc.

Any process or method described in the flowcharts or described in other ways in the embodiments of the present invention may be understood to mean code that includes one or more executable instructions for implementing steps of a specific logic function or process. Modules, segments or sections, and scope of embodiments of the present invention include additional implementations in which functions may be performed in a substantially simultaneous manner or in reverse order, depending on the functionality involved, not in the order shown or discussed. This should be understood by those skilled in the art described in the embodiments of the present invention.

The embodiments of the present invention have been described above with reference to the accompanying drawings, but the present invention is not limited to the above specific embodiments. The above specific embodiments are merely illustrative and not limitative, and those skilled in the art can, under the inspiration of the present invention, make many forms without departing from the protection scope of the present invention and claims, and these are all within the protection of the present invention.

### INDUSTRIAL APPLICABILITY

The touch control method, the user equipment, input processing method, the mobile terminal and intelligent terminal, according to the implementation of the disclosure, can realize the conversion edge touch area according to the rotation and split screen state of the touch screen, so as to better adapt to the user's operation and improve the user experience. On the other hand, because the operation of area A and the operation of area C can only be distinguished at the application framework layer, and the virtual devices are also established at the application framework layer, it can avoid the reliance on hardware when distinguishing between area A and area C in the driver layer. By setting the touch point number, the fingers can be distinguished, which is compatible with A protocol and B protocol. Further, because functions can be integrated into the operating system of the mobile terminal, applicable to different hardware, different kinds of mobile terminals, and having good portability. The input reader automatically saves all parameters of a touch point (coordinates, numbers, etc., of the touch point) to facilitate the subsequent judgment of edge input (for example, FIT).

1. A touch control method, applied in a mobile terminal, the mobile terminal comprises a first display area and a second display area, the method comprising:
detecting a touch signal generated on a touch panel;
identifying a touch point according to the touch signal;
detecting a split screen state and a rotation angle of the mobile terminal;
determining whether the touch point locates in an edge touch area or a normal touch area of the first display area, or locates in an edge touch area or a normal touch area of the second display area according to the identified touch point, the rotation angle and the split screen state; and
performing a corresponding instruction based on a determination result.

2. The touch control method according to claim 1, wherein the rotation angle comprises: rotation of 0 degrees, rotation of 90 degrees clockwise, rotation of 180 degrees clockwise, rotation of 270 degrees clockwise, rotation of 90 degrees counterclockwise, rotation of 180 degrees counterclockwise, and rotation of 270 degrees counterclockwise.

3. (canceled)

4. (canceled)

5. An input processing method for a mobile terminal, the mobile terminal comprising a first display area and a second display area, the method comprising:
obtaining, by a driver layer, an input event based on a touch signal generated by a user through an input device, and reporting to an application framework layer;
according to a rotation angle, a split screen state of the mobile terminal, and the reported input event, determining, by the application framework layer, whether the input event is an edge input event or a normal input event located in the first display area, or is an edge input event or a normal input event located in the second display area; identifying according to a determination result, and reporting an identified result to an application layer;
performing, by the application layer, a corresponding instruction based on the reported identified result.

6. The input processing method according to claim 5, wherein the method further comprises:
creating an input device object with a device ID for each input event.

7. The input processing method according to claim 6, wherein creating an input device object with a device ID for each input event comprising:
making the normal input event corresponds to a touch screen with a first device ID;
setting, by the application framework layer, a second input device object with a second device ID corresponding to the edge input event.

8. The input processing method according to claim 5, wherein obtaining, by a driver layer, an input event based on a touch signal generated by a user through an input device, and reporting to an application framework layer comprises:
assigning, by the driver layer, a number to distinguish fingers for each touch point, and reporting the input event using protocol A.

9. The input processing method according to claim 5, wherein obtaining, by a driver layer, an input event based on a touch signal generated by a user through an input device, and reporting to an application framework layer comprises:
reporting, by the driver layer, the input event using protocol B;
the method further comprising:
assigning, by the application framework layer, a number to distinguish fingers for each touch point in the input event.

10. The input processing method according to claim 5, wherein the rotation angle of the mobile terminal comprises: rotation of 0 degrees, rotation of 90 degrees clockwise, rotation of 180 degrees clockwise, rotation of 270 degrees clockwise, rotation of 90 degrees counterclockwise, rotation of 180 degrees counterclockwise, and rotation of 270 degrees counterclockwise.

11. The input processing method according to claim 10, wherein the split screen state comprising: up-and-down split screen and left-and-right split screen.

12. A mobile terminal, the mobile terminal comprising a first display area and a second display area, further comprising:
an input device;
a motion sensor, configured to detect a current state of the mobile terminal;
a driver layer, configured to obtain an input event generated by a user through the input device and report to an application framework layer;
the application framework layer, configured to determine whether the input event is an edge input event or a normal input event located in the first display area, or is an edge input event or a normal input event located in the second display area according to a rotation angle, a split screen state of the mobile terminal and the reported input event, identify according to a determination result and report an identified result to an application layer;
the application layer, configured to perform a corresponding instruction based on the reported identified result.

13. The mobile terminal according to claim 12, wherein:
the normal input event corresponds to a first input device object with a first device ID;
the application framework layer is further configured to set a second input device object with a second device ID corresponding to the edge input event.

14. The mobile terminal according to claim 12, wherein:
the driver layer reports the input event by using protocol A or protocol B;
when protocol A is used to report the input events, an event acquisition module is configured to assign a number to distinguish fingers for each touch point;
when protocol B is used to report the input event, the application framework layer is configured to assign a number to distinguish fingers for each touch point.

15. The mobile terminal according to claim 12, wherein the driver layer comprises an event acquisition module configured to obtain the input event generated by a user through an input device.

16. The mobile terminal according to claim 12, wherein:
the application framework layer comprises an input reader;
the mobile terminal further comprises a device node disposed between the driver layer and the input reader, and configured to notify the input reader to obtain the input event;
the input reader is configured to traverse the device node to obtain and report the input event.

17. The mobile terminal according to claim 12, wherein, the rotation angle of the mobile terminal comprising: rotation of 0 degrees, rotation of 90 degrees clockwise, rotation of 180 degrees clockwise, rotation of 270 degrees clockwise, rotation of 90 degrees counterclockwise, rotation of 180 degrees counterclockwise, and rotation of 270 degrees counterclockwise.

18. The mobile terminal according to claim 16, wherein the application framework layer further comprises:
a first event processing module, configured to calculate and report a coordinate of the input event reported by an input reader;
a first determination module, configured to determine whether the input event is an edge input event according to the current state of the mobile terminal and the coordinate reported by the first event processing module, and report the input event when the input event is not an edge input event.

19. The mobile terminal according to claim 18, wherein the application framework layer further comprises:
a second event processing module, configured to calculate and report a coordinate of the input event reported by an input reader;
a second determination module, configured to determine whether the input event is an edge input event according to the current state of the mobile terminal and the coordinate reported by the second event processing module, and report the input event when the input event is an edge input event.

20. The mobile terminal according to claim 18, wherein the split screen state comprising: up-and-down split screen and left-and-right split screen.

21. The mobile terminal according to claim 20, wherein the application framework layer further comprises:
an event dispatch module, configured to report the input event reported by the second determination module and the first determination module.

22. The mobile terminal according to claim 21, wherein the application framework layer further comprises:
a first application module;
a second application module;
a third determination module, configured to determine whether the input event is an edge input event according to a device ID of the input event reported by the event dispatch module, report the input event to the first application module when the input event is an edge input event and report the input event to the second application module when the input event is not an edge input event, wherein:
the first application module is configured to identify the normal input event according to relevant parameters of normal input event and report identify result to the application layer;
the second application module is configured to identify the edge input events according to relevant parameters of edge input event and report identify result to the application layer.

23-26. (canceled)
